(19) United States
(12) Patent Application Publication
(10) Pub. No.: US 2012/0049621 A1
(43) Pub. Date: Mar. 1, 2012

(54) BATTERY MANAGEMENT APPARATUS

(75) Inventor: Kokichi SHINODA, Kariya-city (JP)

(73) Assignee: DENSO CORPORATION, Kariya-city (JP)

(21) Appl. No.: 13/192,689

(22) Filed: Jul. 28, 2011

(30) Foreign Application Priority Data
Aug. 27, 2010 (JP) 2010-191024

(51) Int. Cl. B60L 1/00; H02J 9/00

(52) U.S. Cl. 307/10.1; 307/64; 307/65

(57) ABSTRACT

A vehicle carries a battery package as its power source. Each of plural battery modules in the battery package has a memory device for memorizing identification information that proves authenticity of each of the battery modules. A battery control unit in the vehicle has an authentication unit. The authentication unit determines whether or not each of the battery modules is compliant to specification. When the battery module is determined as non-compliant, a control unit drives the vehicle by using a power source other than the non-compliant battery. As the power source other than the non-compliant battery, an internal combustion engine, a supplemental battery, or a compliant battery can be used, thereby preventing damage of the vehicle due to use of the non-compliant battery without deteriorating user convenience of a user of the vehicle.

### CROSS REFERENCE TO RELATED APPLICATION

The present application is based on and claims the benefit of priority of Japanese Patent Application No. 2010-191024, filed on Aug. 27, 2010, the disclosure of which is incorporated herein by reference.

### FIELD OF THE INVENTION

The present disclosure generally relates to a battery management apparatus used in a battery-driven device which operates on an electric power of a battery.

### BACKGROUND INFORMATION

Conventionally, a battery-driven device that operates on an electric power of a battery, and restricts the use of the battery when the battery expires and is non-compliant is disclosed, for example in Japanese Patent document 2008-42985.

According to the above disclosure, the user of the battery-driven device cannot charge the non-compliant battery but can still use the battery-driven device by utilizing the remaining electric power of the battery. However, use of the non-compliant battery may deteriorate the reliability of the battery-driven device. In other words, when the user keeps on using the non-compliant battery, the battery-driven device is operated in a low-reliability condition, which is problematic. Further, use of the non-compliant battery may be continued for a long period of time.

Further, due to the prohibition of charging the battery in the conventional technique, the battery-driven device cannot be operated after the battery is completely discharged. Therefore, the user's convenience of the conventional battery-driven device is seriously deteriorated.

### SUMMARY OF THE INVENTION

In view of the above and other problems, the present application provides a battery management apparatus which, while preventing damage of the battery-driven device due to use of the non-compliant battery, improves the user convenience of the battery-driven device when the non-compliant battery is used in the battery-driven device.

The present application uses following techniques for achieving the above-described objectives.

In an aspect of the present invention, a battery management apparatus includes: a battery checker that determines if a battery used in a battery-driven device is a compliant battery or a non-compliant battery; and a control unit that operates the battery-driven device by using a power source other than the non-compliant battery, when the battery checker determines that the battery is a non-compliant battery.

According to the above configuration, when a non-compliant battery is installed, the battery-driven device is operated by only using a power source other than the non-compliant battery. Therefore, damage of the battery-driven device due to use of the non-compliant battery is prevented. Further, the user can still use the battery-driven device. Therefore, deterioration of user convenience is prevented.

Further, the battery-driven device is a vehicle that uses the battery as a power source. According to this configuration, the vehicle can still be operated even when the non-compliant battery is used in the vehicle.

Further, the battery management apparatus described above further includes a charge prohibition unit that prohibits the non-compliant battery from being charged. According to this configuration, the charging of the non-compliant battery is prohibited. Therefore, damage of the battery-driven device due to use of the non-compliant battery is prevented.

Further, the control unit operates the battery-driven device by an internal combustion engine without using the non-compliant battery. According to this configuration, the battery-driven device is operated by using the internal-combustion engine as its power source.

Further, the battery includes a plurality of sub-battery-components, and the battery checker determines the compliance of selected sub-battery-components of the battery. Furthermore, the control unit operates the battery-driven device with sub-battery-components other than the non-compliant sub-battery-components. According to this configuration, the operation of the battery-driven device by using a non-compliant portion of sub-battery-components is prevented.

Further, the battery management apparatus further includes a selection unit that selects the sub-battery-components based on information received from the control unit, to provide the battery-driven device with electric power from sub-battery-components other than the non-compliant sub-battery-components. According to this configuration, the operation of the battery-driven device by using a non-compliant portion of battery cells is prevented.

Further, one of the sub-battery-components is a primary battery, and one of the sub-battery-components is a supplemental battery. Where the battery checker determines if the primary battery is compliant or non-compliant. Furthermore, the control unit operates the battery-driven device by using only the supplemental battery when the battery checker determines that the primary battery is non-compliant. According to this configuration, when the non-compliant battery is installed as the primary battery, the battery-driven device is operated by using the supplemental battery as its power source.

Further, the sub-battery-components may be a plurality of battery modules, and the battery checker determines the compliance of each of the battery modules. Furthermore, the control unit operates the battery-driven device by only using the compliant battery modules. According to this configuration, from among plural modules in the battery, only the compliant modules are used to operate the battery-driven device.

### BRIEF DESCRIPTION OF THE DRAWINGS

Objects, features, and advantages of the present disclosure will become more apparent from the following detailed description made with reference to the accompanying drawings, in which:

FIG. 1 is a block diagram of a battery management apparatus in a first embodiment of the present application;

FIG. 2 is a block diagram of a vehicle part of the battery management apparatus in the first embodiment;

FIG. 3 is a flowchart of control of the battery management apparatus in the first embodiment;

FIG. 4 is a flowchart of control of the battery management apparatus in the first embodiment;

FIG. 5 is a flowchart of control of the battery management apparatus in the first embodiment;

FIG. 6 is a flowchart of control of the battery management apparatus in the first embodiment;

FIG. 7 is a block diagram of a vehicle part of the battery management apparatus in a second embodiment;

FIG. 8 is a flowchart of control of the battery management apparatus in the second embodiment;

FIG. 9 is a block diagram of a vehicle part of the battery management apparatus in a third embodiment;

FIG. 10 is a flowchart of control of the battery management apparatus in the third embodiment; and

FIG. 11 is a flowchart of control of the battery management apparatus in the third embodiment.

### DETAILED DESCRIPTION

In the following, embodiments of the present application are described with reference to the drawing. Like parts have like numbers in those embodiments, and redundant portions may be omitted from some of those embodiments for brevity. When only a part of the configuration is explained in an embodiment, the rest of the configuration is supplemented by the configuration of preceding embodiments. Combinations of embodiments should not be limited unless expressly restricted or there is hindrance to prohibit the combination.

### First Embodiment

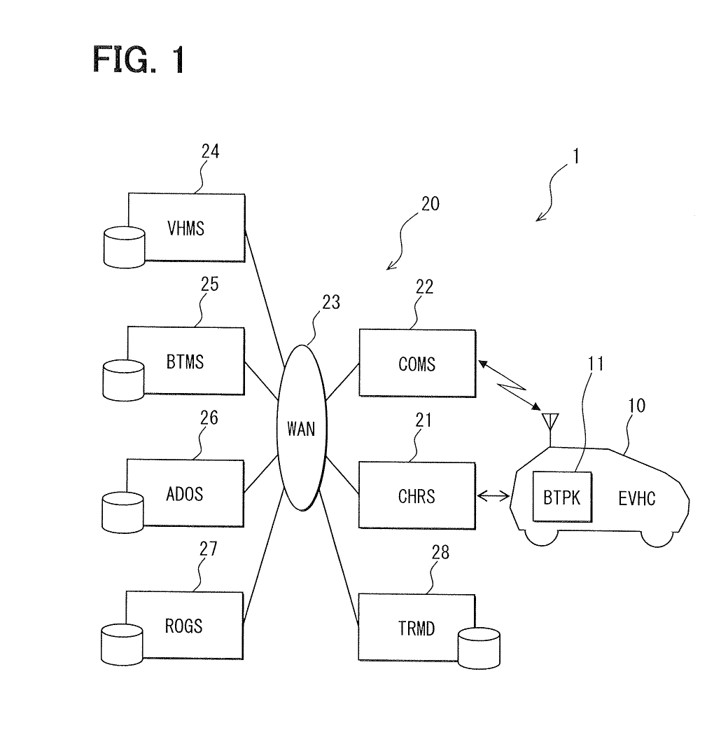

With reference now to FIG. 1 a battery management apparatus 1 comprises a vehicle (EVHC) 10 and a ground facility 20 disposed on the ground. The vehicle 10 is a battery-driven device operated by a battery 11. The vehicle 10 generates at least a part of its driving power by using a motor. For example, the vehicle 10 may be a battery car driven only by a motor, or a hybrid car in which an internal combustion engine is used together with the motor.

The ground facility 20 includes a charge station (CHRS) 21 and a communication facility (COMS) 22. The charge station 21 includes a charger for charging the battery 11 in the vehicle 10 and a data communications equipment to connect to a wide area network (WAN) 23. The communication facility 22 is a communications equipment of a communication company, and is wirelessly communicable with communication equipment in the vehicle 10. For example, the communication facility 22 is a ground station of a mobile telephone service company. The communication facility 22 includes a data communications equipment to connect to WAN 23. WAN 23 serves as a communication line. For example, WAN 23 is provided through Internet.

The ground facility 20 also includes a server of vehicle manufacturers (VHMS) 24, a server of battery manufacturers (BTMS) 25, a server of administrative organization (ADOS) 26, and a server of related organizations (ROGS) 27, which may be referred to as servers 24, 25, 26, 27. Servers 24, 25, 26, 27 are connected to WAN 23. The components of the ground facility 20, that is, charge station 21, the communication facility 22, the server 24, 25, 26, 27, are in mutual communication through WAN 23.

The ground facility 20 may be equipped with an input terminal 28. For example the input terminal 28 may be a personal computer connectable to WAN 23, a portable terminal, or a cellular phone. The input terminal 28 is connectable to the server 24, 25, 26, 27 in the ground facility 20. That is, for example, through communication to the server ADOS 26, the input terminal 28 sets, modifies, or initializes information regarding authentication of the battery 11, together with other processes. The input terminal 28 may be provided as a navigation apparatus including a display unit 15 on the vehicle 10.

The server 24, 25, 26, 27 each include a recording device for recording information provided from WAN 23. The contents of the recording device can be used by the individual servers, and can also be read by a third party. The server VHMS 24 can be read by a manufacturer of the vehicle 10. The manufacturer of the vehicle 10 is an organization related to a battery-driven device, and may be designated as a responsible organization which is responsible for the vehicle 10. The server BTMS 25 can be read by a manufacturer of the battery 11. The manufacturer of the battery 11 is an organization related to the battery, and may be designated as a responsible organization that is responsible for the battery 11.

The responsible organization(s) may be responsible for product liability, a service provision obligation for providing a service that is designated in a contract paper, a social responsibility for preventing an accident and providing relief, together with other responsibilities. For example, the vehicle manufacturer of the vehicle 10 and the battery manufacturer of the battery 11 are considered to bear a few responsibilities regarding their products and its use.

The server VHMS 24 of the vehicle manufacturer has a recording device for recording information provided from WAN 23. The contents of the recording device can be used in the server VHMS 24, and can be read by a manufacturer of the vehicle 10. The server BTMS 25 of the battery manufacturer has a recording device for recording information provided from WAN 23. The contents of the recording device can be used in the server BTMS 25, and can be read by a manufacturer of the battery 11.

The server ADOS 26 can be read by an administrative organization. The administrative organization is an organization related to a battery-driven device or a battery. The administrative organization may be a public organization for substantially administering the responsible organization that is responsible for the vehicle 10 or the battery 11. The public organization includes an organization belonging to a national government or a local government, such as, a governmental organization controlling road traffic, a governmental organization controlling a consumer safety, or the like. The public organization may include a “substantially” public organization, such as, a product authentication organization for authenticating a product such as a battery that has passed a quality test, a performance test or the like. Such an organization may include a non-governmental organization related to a traffic safety or a consumer safety, a non-profit organization, or a corporation. For example, the public organization includes an organization providing security for the vehicle 10 or the battery 11, an insurance company for providing insurance for the vehicle 10 or the battery 11, and an organization for organizing a vehicle user membership. The public organization may further include a non-profit organization that promotes a vehicle safety through public advertisement. These public organizations directly or indirectly control and substantially administer the responsible organizations. That is, the governmental organization controls and administers the vehicle manufacturers and the battery manufacturers based on applicable laws and regulations. Further, the companies and corporations as well as non-profit organizations may also control and administer, through advertisement and information communication to the public, the vehicle manufacturers and the battery manufacturers.

The server ROGS 27 may be read by a related organization, which is an organization related to the vehicle 10 and the battery 11. For example, the related organization may include a police department, an organization related to credit information of the user of the vehicle 10 that provide authentication for personal information of the user, an insurance company providing insurance for the vehicle 10 or the battery 11 may be included in the related organization, or the like

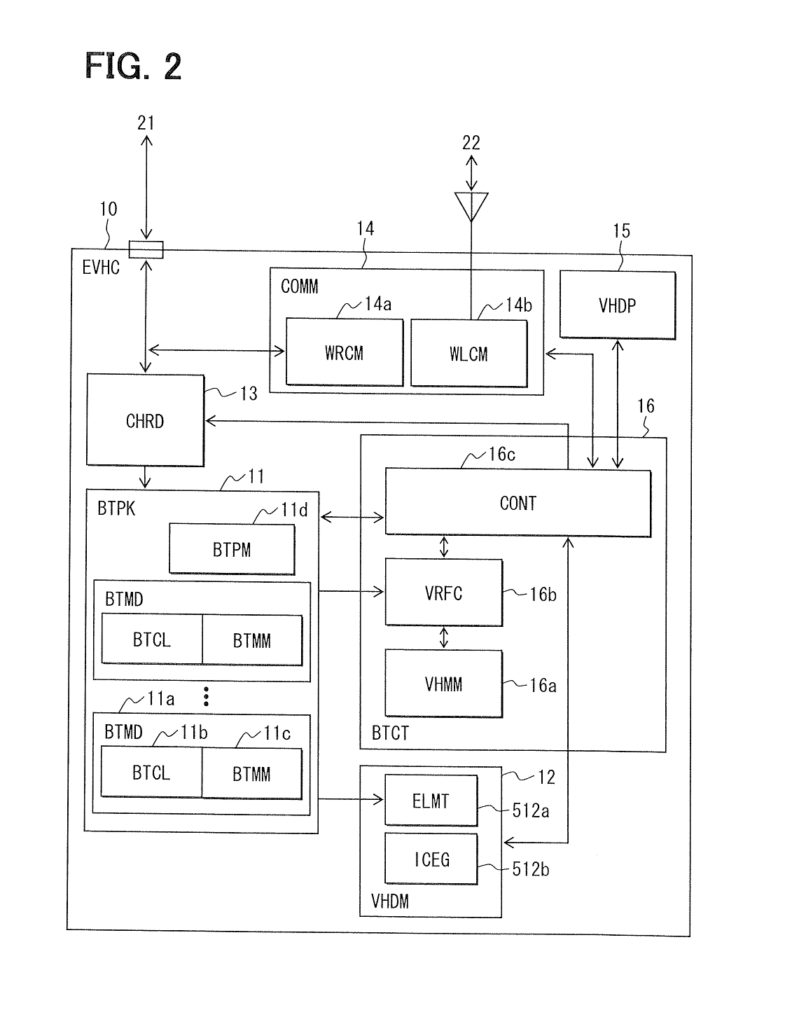

FIG. 2 is a block diagram of a vehicle part disposed in the vehicle 10 of the battery management apparatus 1. In the battery management apparatus 1, the battery 11 is installed in the vehicle 10. The battery 11 may be referred to as battery package (BTPK) 11. The battery package 11 has a plurality of battery modules (BTMD) 11a installed thereon. Each of the battery modules 11a is replaceable. The battery module 11a includes a battery cell (BTC) 11b and a memory device (BTMM) 11c. The battery cell 11b is a basic component of the battery 11. The battery cell 11b may be a lithium ion battery. The memory device 11c is a part of the battery 11, which cannot be removed from the battery module 11a without breaking it. The memory device 11c memorizes authentication information to authenticate the battery module 11a. The authentication information may include identification information (ID) of the battery module 11a and management information. The identification information may include a code showing that the battery module 11a is a genuine battery and a code showing that the battery module 11a is distributed to an authorized distribution channel. The management information is for managing a use of the battery module 11a compliant to a specification. That is, the management information specifies a warranty period, a maximum number of use, a charge condition, a discharge condition, and the like of the battery module 11a. The memory device 11c memorizes security information related to the battery 11.

Further, the battery package 11 includes a storage device (BTPM) 11d. The storage device 11d memorizes management information about the whole battery package 11. The management information specifies a warranty period, a charge condition, a discharge condition, and the like of the whole battery package 11. Further, the charge condition of the whole battery package 11 specifies, as a condition of restricted charging, a restricted charge amount and a restricted number of charging.

In the vehicle 10, a genuine battery specified by a vehicle maker or a non-genuine battery that is compatible with the genuine battery may be used as the battery 11 or the battery module 11a. For example, the “genuine” battery may indicate a battery that is specified by a maker of the vehicle 10, or a seller of the vehicle 10. Further, the “genuine” battery may indicate a battery that is specified by both the maker of the vehicle 10 and the maker of the battery 11 as a suitable battery for use in the vehicle 10. Furthermore, the “genuine” battery may indicate a battery that is specified by an organization of the makers of the vehicle 10 and/or the makers of the battery 11. The “genuine” battery may include a near-genuine battery that is specified by a public organization, or a near-genuine battery that is specified by an organization of makers and/or sellers. In other words, a battery is proven to be “genuine” not by a label on the battery but by a battery authentication performed by a computer in the vehicle 10.

The non-genuine battery means batteries without warranty, or without authentication by a reliable organization. Those batteries may be designated as a non-compliant battery. The non-genuine batteries may or may not have recorded information on a responsibility of the product (e.g., a product liability), which can be readable by a computer, for identifying a person, a company, or an organization in charge of the battery. Those non-genuine batteries cannot be authenticated by a computer in the vehicle 10. The non-genuine battery may be called as a third party product, or a copy product.

The battery 11 is not considered as “properly-functioning” when the warranty period is expired, or when the maximum times of use is surpassed. That is, even when the battery 11 is a genuine one, the warranty-expired battery or the surpassed max-use-time battery is not considered as “properly-functioning”, and may also be referred to as an “improper battery”. The improper battery are batteries that are not in proper use condition, or are in a no-guarantee condition for use, which may also include a battery that may be broken. The properly-functioning battery can be authenticated by a computer in the vehicle 10. The properly-functioning battery may also be referred to as a proper battery or the like. An improper battery may also be referred to as not properly-functioning battery or the like.

Further, a legally-acquired battery and an illegally-acquired battery are included in a category of the genuine battery. The legally-acquired battery is acquired via an authorized distribution channel, and installed in the vehicle 10 by an authorized procedure. The illegally-acquired battery is a battery acquired illegally from an un-authorized channel or the like. For example, stolen products are categorized as an illegally-acquired battery. The legally-acquired battery can be authenticated by a computer in the vehicle 10.

A “compliant” battery means that a battery is (a) a genuine one, (b) a properly-functioning one, and (c) a legally-acquired one. A non-compliant battery means that a battery is either (d) a non-genuine one, (e) a not properly-functioning one, or (f) an illegally-acquired one. In other words, when a battery is expressed as “compliant” or “normal”, the battery is a genuine one, a properly-functioning one, and a legally-acquired one. When a battery is expressed as “non-compliant” or “abnormal”, the battery is either a non-genuine one, not properly-functioning one, or an illegally-acquired one.

The vehicle 10 has a drive mechanism (VHDM) 12 installed therein. The drive mechanism 12 drives the vehicle 10 on electricity supplied from the battery 11. The drive mechanism 12 includes an electric motor (ELMT) 512a. Further, the drive mechanism 12 may include an internal combustion engine (ICEG) 512b generating a driving power of the vehicle 10. In the present embodiment, the internal combustion engine 512b is a power source used to drive the vehicle 10. The internal combustion engine 512b can drive the vehicle 10 without help of the battery 11 or in place of the battery 11 and the electric motor 512a.

The vehicle 10 has a charge device (CHRD) 13 installed therein. The charge device 13 controls the charging of the battery 11. When the vehicle 10 is connected to the charge station 21 by a charge line, the charge device 13 controls the charging of the battery 11 by the charge station 21. The charge device 13 may have a breaker for permitting and prohibiting charging of the battery 11 according to an input signal from outside of the device 13. According to the input signal, the charge device 13, which may have a charge amount control unit for controlling the amount the battery 11 is charged, controls the charge of the battery 11 to a certain amount between a minimum charge amount and a maximum charge amount.

The vehicle 10 has a communication device (COMM) 14 installed therein. The communication device 14 is in communication with at least one server through a wired connection or a wireless connection. The communication device 14 includes a wired communication device (WRCM) 14a communicating with the charge station 21 through a charge line. Further, the communication device 14 includes a wireless communication device (WLCM) 14b communicating wirelessly with the communication facility 22 through a cellular phone network. The communication device 14 transmits data to an outside server, (i.e., a memory device outside of the communication device 14), through one of the wired communication device 14a or the wireless communication device 14b. The communication device 14 is in communication with at least one of the server VHMS 24 of the vehicle manufacturer and the server ADOS 26 of the administrative organization.

The vehicle 10 has a display unit (VHDP) 15 installed thereon. The display unit 15 displays a message for the user, such as a driver of the vehicle 10. In addition, the user of the vehicle may mean an owner of the vehicle, a manager of the vehicle, a driver of the vehicle, or a passenger of the vehicle. The display unit 15 may be provided as a meter unit, a navigation unit, or an imaging device on the vehicle 10.

The vehicle 10 has a battery control unit (BTCT) 16 installed thereon. The battery control unit 16 is provided as a microcomputer equipped with a computer-readable storage medium. The storage medium stores a computer-readable program. The storage medium may be provided as a memory. The program may be executed by a control unit for controlling the battery control unit 16 to be serving as a device described in this specification. The battery control unit 16 further includes a memory unit (VHMM) 16a, an authentication unit (VRFC) 16b and a control unit (CONT) 16c. These components 16a, 16b, 16c may be provided as a microcomputer circuit and a program executed therein.

The battery control unit 16 controls the battery 11, the drive mechanism 12 and the charge device 13 so that the battery 11 is used properly. The battery control unit 16 is configured to perform the above-described control according to a condition of the battery 11. The battery control unit 16 further performs an authentication control to restrain the use of a non-compliant battery, while preventing inconvenience of to user. The battery control unit 16 has a battery checker for checking whether a battery is compliant to a maker-specified requirement. Further, the battery control unit 16 controls the charge device and/or the drive mechanism according to a check result of the battery checker and a transmission unit for sending out relevant information through a communication channel according to the check result of the battery checker. The above-described function units of the battery control unit 16 may be called as function blocks or modules.

A battery management apparatus 1 includes, as a main component, the battery control unit 16 that may be installed in the vehicle 10. A part of the battery management apparatus 1, such as the battery checker of the battery control unit 16, can be included in the ground facility 20. Further, information indicative of the use of a non-compliant battery may be configured to be relayed by a plurality of servers, to be stored in an intended recording device. In such a configuration, a part of the transmission unit is installed in the ground facility 20.

The memory unit 16a of the battery control unit 16 memorizes authentication information to authenticate the battery 11. The authentication information, which may also be referred to as the maker-specified requirement, may include a code to authenticate a genuine battery, a code to authenticate a properly-functioning battery, and a code to authenticate a legally-acquired battery.

An authentication unit 16b of the battery control unit 16 serves as the battery checker for checking whether the battery is compliant or non-compliant based on whether the battery is genuine, properly-functioning, and legal. The authentication unit 16b includes a reader unit for reading the identification information and the management information from the battery 11 as well as a retrieval unit for retrieving the authentication information memorized in the memory unit 16a. The authentication unit 16b determines whether each of the battery modules 11a is compliant or non-compliant.

The authentication unit 16b includes means to determine whether a battery is a genuine or non-genuine battery based on the authentication information and the identification information. The authentication unit 16b determines whether a battery is genuine for each of the battery modules 11a. The determination of whether a battery is a genuine or non-genuine can be determined using various techniques. For example, predetermined identification information is issued only for a genuine battery. The manufacturer of the battery 11 stores the issued information to the memory device 11c. The authentication information is registered in the memory unit 16a. When the identification information accords or is the same as the authentication information, the authentication unit 16b authenticates the battery 11 as a genuine one. When the identification information is not the same as the authentication information, the authentication unit 16b authenticates the battery 11 as a non-genuine one. When the battery module 11a is disposed in the vehicle 10, a code, which should be the same as the identification information, may be registered in the memory unit 16a as the authentication information. By employing a particular procedure or a particular device for reading the identification information from the memory device 11c or for registration of the authentication information in the memory unit 16a, unauthorized registration is prevented.

In another technique, the genuine battery may have the identification information issued with a predetermined encrypting code. The manufacturer of the battery 11 stores the issued identification information to the memory device 11c. The memory unit 16a has a code registered therein as the authentication information for decrypting the identification information. The authentication unit 16b decrypts the identification information by using the registered authentication information, and the decrypted information authenticates the battery as a genuine one when the decrypted information is an expected one. Furthermore, in yet another scheme, predetermined identification information is issued only for a genuine battery. The authentication unit 16b accesses the server ROGS 27 of the related organization through the communication device 14, and determines whether the identification information is of a genuine battery. In this case, the battery checker is realized as a combination of the authentication unit 16b and the server ROGS 27. The authentication scheme of the genuine battery based on the identification information may be implemented by employing various authentication techniques.

Based on the management information the authentication unit 16b includes a means for determining whether a battery is properly functioning or not properly-functioning. The authentication unit 16b determines whether a battery is properly-functioning for each of the battery modules 11a. The determination whether or not a battery is properly-functioning can be carried out by the following process. The memory device 11c memorizes warranty information indicative of a warranty period of the battery 11 the management information. The authentication unit 16b determines whether the warranty period has expired. If the warranty period has not expired, the battery 11 is determined as properly-functioning or proper. If the warranty period has expired, the battery 11 is determined as not properly-functioning or improper and is non-compliant. In another process, the memory device 11c memorizes information indicative of a maximum number of charge operations as the management information. The authentication unit 16b determines whether the maximum number of charge operations is surpassed. If the maximum number of charge operations is not surpassed, the battery 11 is determined as properly-functioning. If the maximum number of charge operations is surpassed, the battery 11 is determined as not properly-functioning or improper and as is non-compliant.

Based on the authentication information and the identification information, the authentication unit 16b includes means to determine whether a battery is a legally-acquired or an illegally-acquired battery, and does so for each of the battery modules 11a. The determination whether or not a battery is a legally-acquired battery can be carried out by the following process. A predetermined identification information is issued only for a genuine battery supplied to an authorized distribution channel. The manufacturer of the battery 11 stores the issued identification information to the memory device 11c. When the battery module 11a acquired via the authorized distribution channel is installed in the vehicle 10, predetermined and authorized registration processing is carried out. By the registration processing, the authentication information same as the identification information is registered to the memory unit 16a. When the identification information accords with authentication information, the authentication unit 16b authenticates the battery module 11a as a legally-acquired product. When it does not, the battery module 11a is an illegally-acquired product and is non-compliant. The authentication process of the legally-acquired battery based on the identification information may be implemented by employing various authentication techniques.

Based on the authentication result by the authentication unit 16b, the control unit 16c controls the battery 11, the charge device 13, and the drive mechanism 12. The control unit 16c may provide means to allow or prohibit charging according to the authentication result, means to limit an electricity charge amount according to the authentication result, and means to restrict travel of the vehicle by using the battery 11 according to the authentication result. When a non-compliant battery is used, the control unit 16c and the communication device 14 serve as a transmission unit for sending out, to the external servers VHMS 24, ADOS 26 through WAN 23, information indicative of the use of the non-compliant battery 11.

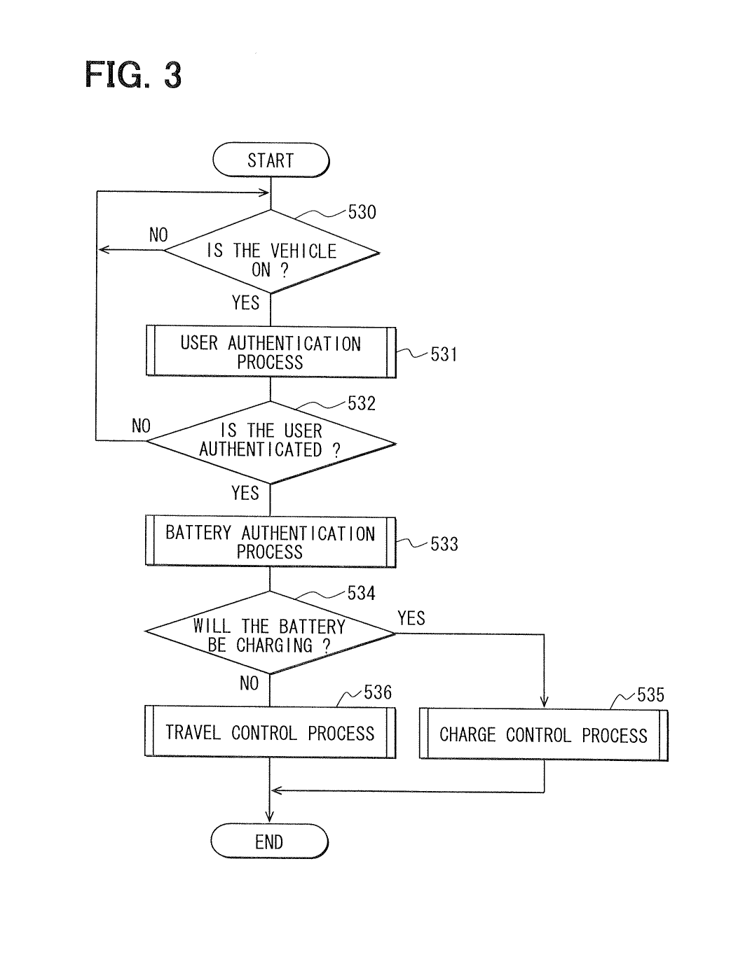

The operation of the battery management apparatus of the first embodiment is explained with reference to FIGS. 3, 4, 5, 6. FIG. 3 is a flowchart showing an operation of the battery management apparatus 1 of the vehicle 10. In step 530 it is first determined whether the vehicle 10 has been started. In other words, when an occupant gets in the vehicle 10, it is determined whether or not a power switch of the vehicle 10 is operated to an “ON” position. When it is determined that the use of the vehicle 10 has not started, the process returns to step 530. When it is determined that the use of the vehicle has started, the process proceeds to step 531. In step 531, a user authentication process is carried out to determine whether the person who is going to use the vehicle 10 has the proper authority. For example, it is determined whether a key or an electronic code used by the user has authenticity. In step 532, it is determined whether use of the vehicle 10 is approved by the user authentication of step 531. When use of the vehicle 10 is prohibited, the process returns to step 530. When use of the vehicle 10 is permitted the process proceeds to step 533.

The user authenticity process in steps 530 to 532 is carried out by a security device belonging to the vehicle 10 or an immobilizer belonging to the drive mechanism 12. Note that the user authentication process in step 531 is different from the battery authentication process in later step 533. Security of the battery information is improved by carrying out the battery authentication process after an affirmative determination in the user authentication.

In step 533, the battery authentication process is carried out, and is described in detail further below. The battery authentication process may be carried out by the authentication unit 16b and the control unit 16c. In step 534, it is determined whether the user is going to charge the battery 11. When the user stops the vehicle 10 in front of the charge station 21 and connects a charge line to the vehicle 10, the process proceeds to step 535. In step 535, a charge process to charge the battery 11 is carried out. The charge process is carried out by a control unit belonging to the charge device 13. The charge process refers to the authentication result from the battery authentication process in step 533, and the charge process is carried out based on the authentication result.

In step 534, if it is determined that the user is not charging the battery 11, the process proceeds to step 536. In step 536, a travel control process is carried out to use the battery 11 as a power source. The travel control process is carried out by a control unit belonging to the drive mechanism 12. The travel control process refers to the authentication result from the battery authentication process in step 533, and the travel control process is carried out based on the authentication result.

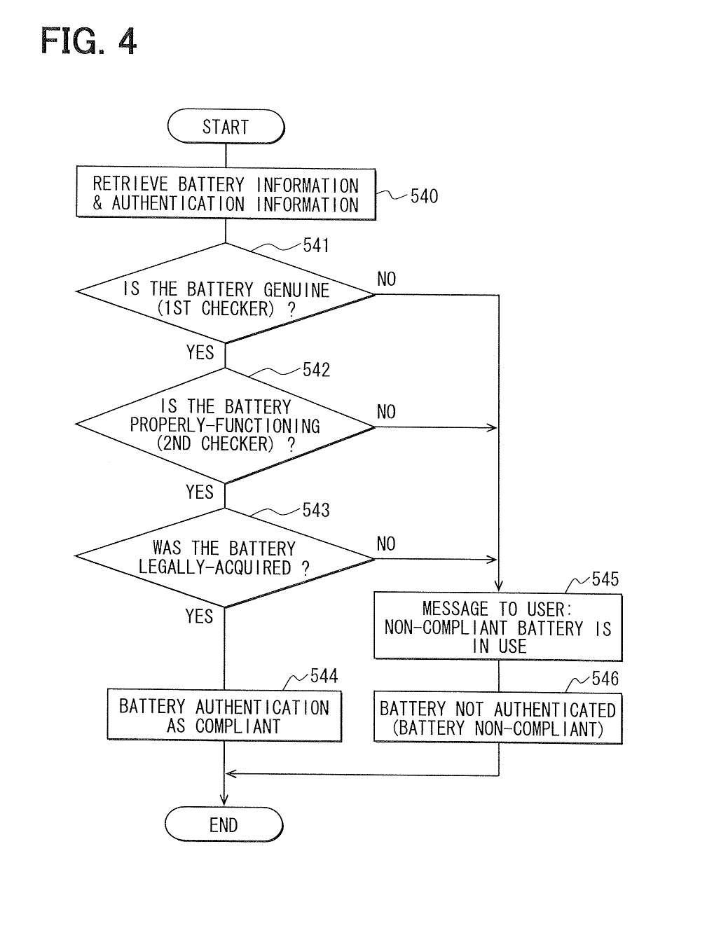

FIG. 4 is a flowchart of the battery authentication process of step 533. Steps 540-546 serve as a battery checker for determining whether the battery 11 is a compliant battery or a non-compliant battery (i.e the battery checker checks the compliance of a battery). In step 540, the identification information and battery information including management information are retrieved from the battery 11. Further in step 540, the authentication information or maker-specified requirement memorized in the memory unit 16a is also retrieved.

In step 541, it is determined whether the battery 11 is a genuine battery suitable for the vehicle 10 based on the identification information and the authentication information. This determination can be carried out based on whether a code showing a genuine product is included in the identification information. Step 541 serves as “a first checker” to determine whether a battery is a genuine battery. Step 541 is carried out for each of the battery modules 11a. The process proceeds to step 545 if any one of the battery modules 11a is found to be non-genuine. The process proceeds to step 542 if all of the battery modules 11a are genuine.

In step 542, based on the management information retrieved from the battery 11, it is determined whether the battery 11 is properly-functioning. Step 542 serves as “a second checker” and is carried out for each of the battery modules 11a. The process proceeds to step 545 when any one of the battery modules 11a is found to be not properly-functioning. The process proceeds to step 543 if all of the battery modules 11a are properly-functioning.

In step 543, it is determined whether the battery 11 is a legally-acquired battery. In other words, it is determined if the battery 11 is acquired via the authorized distribution channel, and it is determined whether the battery 11 is installed in the vehicle 10 by an authorized procedure. This determination can be carried out by determining whether the identification information is associated with the information that is unique to the vehicle 10. Step 543 is carried out for each of the battery modules 11a. The process proceeds to step 545 when any one of the battery modules 11a is found to be illegally-acquired.

If the process determined that all of the battery modules 11a were legally acquired the battery 11 is determined to be a compliant or normal battery because it was determined as a genuine battery in step 541, a properly-functioning battery in step 542, and a legally-acquired battery in step 543. Thus, in step 544, it is recorded that the battery 11 is authenticated as compliant. Because the battery 11 is determined as complaint, a normal charge control for the battery 11 and a normal travel control for the vehicle 10 are permitted thereafter.

When the battery 11 is determined as non-genuine in step 541, or as not properly-functioning in step 542, or as illegally-acquired in step 543, the battery 11 is considered to be a non-complaint or abnormal battery. In step 545, the user of the vehicle 10 is notified of the use of the non-compliant battery 11 by displaying a message to the user on the display unit 15. In step 546, non-authentication of the battery 11 is memorized. That is, the fact that the battery 11 is a non-compliant battery is memorized in step 546. Thereafter, the use of the non-compliant battery is restricted by the charge control process of step 535 and the travel control process of step 536.

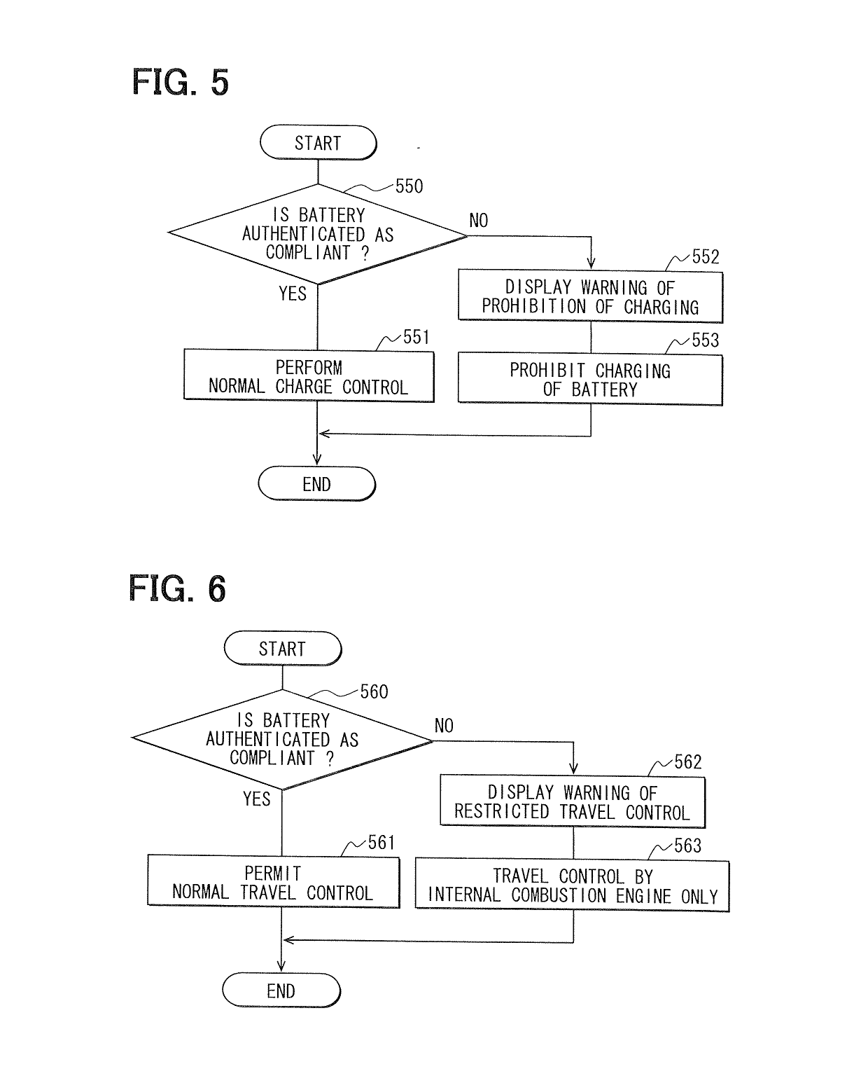

FIG. 5 is a flowchart of the charge control process. In step 550, the authentication result in step 544 or step 546 is referred to. When the battery 11 has been authenticated as a compliant battery, step 551 is performed for a normal charge control, and a regular charger for charging the battery under a normal charge condition is provided. In step 551, the battery 11 is charged to the maximum charge capacity of the battery 11. In other words, the user can charge the battery 11 without restriction when the battery 11 is a compliant battery.

When the battery 11 is not authenticated as a compliant battery (i.e is a non-compliant battery), steps 552 and 553 are performed for performing a restricted charge control. In steps 552 and 553, the charge amount is set to zero. In such a restricted condition, the user suffers a certain amount of inconvenience. Therefore, switching to a compliant battery is prompted for the user. In step 552, the user is notified of the prohibition of charging due to the use of a non-compliant battery. The warning message indicative of the prohibition of charging may be displayed on the display unit 15.

In step 553, the charging of the non-compliant battery 11 is prohibited, such that the charging of the battery 11 from the charge device 13 is stopped. Step 553 serves as a charge prohibition unit for prohibiting charging of the non-compliant battery in case the battery checker determines that a non-compliant battery is installed.

FIG. 6 is a flowchart of the travel control process of step 536. In step 560, the authentication result in step 544 or step 546 is referred to. When the battery 11 has been authenticated as a compliant battery, step 561 is performed for a normal travel control, and step 561 serves as a travel control unit for allowing a predetermined function of the battery-driven device. The normal travel control in step 561 allows the user to use the full capacity of the battery 11 for the travel of the vehicle 10. In other words, the user can fully utilize the battery 11 and the vehicle 10 to their maximum capacity.

When the battery 11 has not been authenticated as a compliant battery, in other words is a non-compliant battery, steps 562 and 563 are performed for a restricted travel control. When the battery checker determines that a non-compliant battery is installed, steps 562 and 563 serve as a control unit that controls the battery-driven device to use a power source other than the non-compliant battery.

In step 562, the user of the vehicle 10 is notified of the restricted travel control due to the use of the non-compliant battery. The warning message indicative of the restricted travel control may be displayed on the display unit 15. Further, the contents of the restricted travel control may also be displayed.

In step 563, the control unit 16c sends an instruction to the drive mechanism 12 to only use the internal combustion engine 512 to power the vehicle 10, and not to use the non-compliant battery 11 of the electric motor 512a. The travel control in step 563 is configured not to use the remaining electric power of the battery 11. Therefore, use of the non-compliant battery 11 is completely stopped. That is, the travel control in step 563 actively prohibits the use of the battery 11. This active prohibition of the use of the battery 11 is clearly different from a passive travel control that drives the vehicle 10 by the internal combustion engine 512b after discharge of the battery 11. The control unit provided by step 563 is configured to drive the battery-driven device by the internal combustion engine 512b without using the electric power of the non-compliant battery when the non-compliant battery is installed in the vehicle 10.

According to the present embodiment, the vehicle 10 is driven by the internal combustion engine 512b without using the non-compliant battery 11, when the non-compliant battery 11 is installed in the vehicle 10. In other words, the battery-driven device is operated by using a power source other than the non-compliant battery 11. Therefore, the damage or potential harm due to the use of the non-compliant battery is prevented. Further, the user can still drive/operate the battery-driven device, preventing any inconvenient to the user.

### Second Embodiment

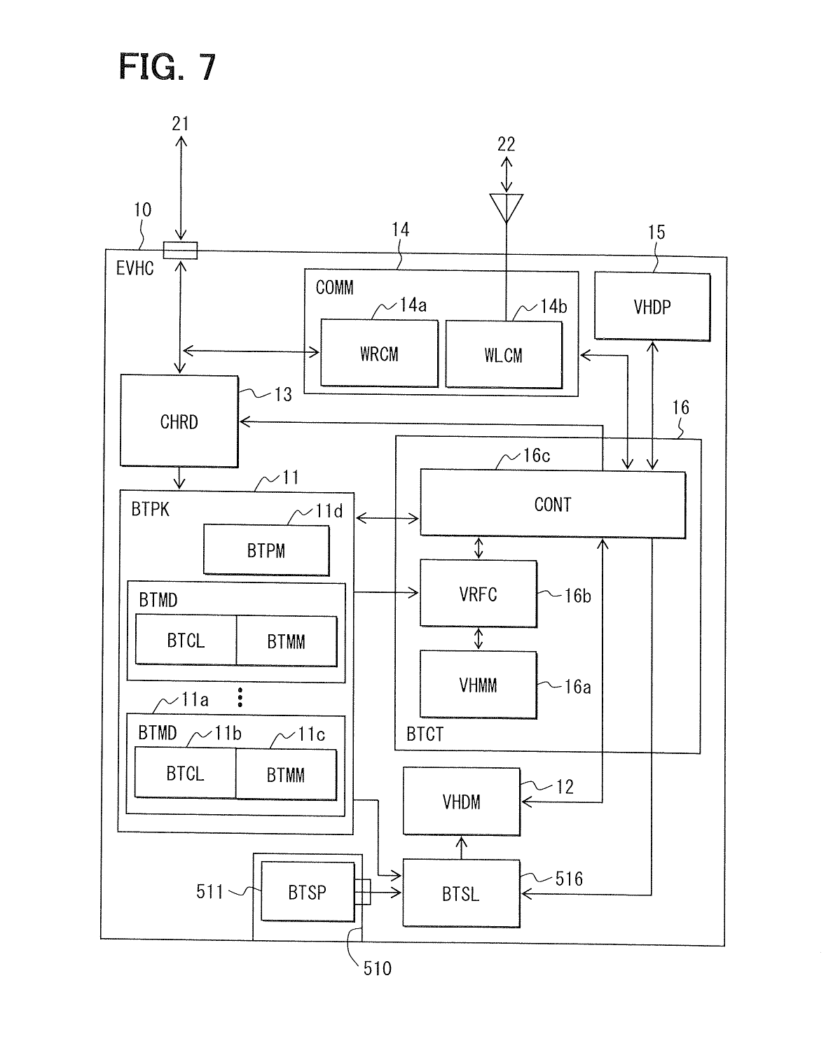

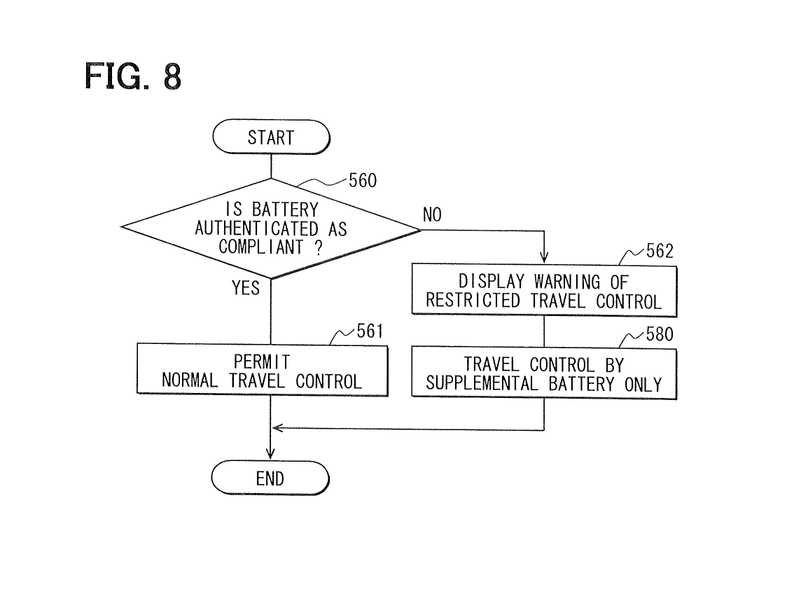

In the second embodiment, the configuration in FIG. 2 of the previous embodiment is replaced with the configuration in FIG. 7. Further, the travel control shown in a flowchart of FIG. 6 of the previous embodiment is replaced with the travel control in FIG. 8. The system configuration in FIGS. 1, 3 to 5 is used in common with other embodiments.

FIG. 7 shows a block diagram of a part of a battery management apparatus disposed in the vehicle 10. Like numbers refer to like steps in FIG. 2. In the present embodiment, the vehicle 10 has a supplemental battery (BTSP) 511 that can be coupled to a battery housing 510, so that the power from the supplement battery 511 may be utilized. The supplemental battery 511 is provided as a cartridge that can be carried by the user, and is detachable from the battery housing 510. The battery housing 510 and the supplemental battery 511 are more easily engaged with each other in comparison to the battery module 11a. That is, the battery 511 can be more easily detachable from and installable to the battery housing 510 than the battery module 11a. The supplemental battery 511 is an option part that is selectively disposed in the vehicle 10. The vehicle 10 is drivable only on the battery 11 if it is compliant, in which case the supplemental battery 511 is not used. On the other hand, if the battery 11 is a non-compliant battery, the vehicle 10 may not utilize the power of battery 11, and has to use another power source. In such a case the vehicle 10 utilizes the power of the supplemental battery 511. The supplemental battery 511 has a smaller electrical charge capacity than the battery 11, and may be set to an amount that allows the user to drive the vehicle to the nearest service station.

In the present embodiment, the battery 11 and the battery 511 may be considered as sub-battery-components to one main battery, where the battery 11 serves as the primary battery and the battery 511 serves as the supplemental battery. The battery checker, provided by in steps 540 to 543, is configured to check whether the battery 11, the primary battery, is compliant or non-compliant while the supplemental battery 511 is configured to be usable without authentication. Therefore, the battery checker can be configured to check certain sub-battery-components of the main battery, and not others.

The vehicle 10 has a selection unit (BTSL) 516 disposed therein. Based on an instruction from the control unit 16c, the selection unit 516 selects either the battery 11 or the supplement battery 511. When the battery 11 is selected as a power source the selection unit 516 supplies the electric power of the battery 11 to the drive mechanism 12. When the supplemental battery 511 is selected as a power source, the selection unit 516 supplies electric power of the supplemental battery 511 to the drive mechanism 12. In other words, the battery control unit 16 may select a sub-battery-component of the main battery, and the selection unit 516 supplies power from the selected sub-battery-component to the battery-driven device. That is, in the control unit, the selection unit 516 is provided for selective power supplies from plural battery parts. The battery parts may be designated as a plurality of battery cells.

FIG. 8 shows a flowchart of a travel control process for the second embodiment of the vehicle 10. Like numbers refer to like steps in FIG. 6. Step 580 is performed when battery 11 is a non-compliant battery. In step 580, the control unit 16c instructs the selection unit 516 to supply the drive mechanism 12 with electric power from only the supplemental battery 511, which restricts the use of the non-compliant battery 11. The control unit 16c prevents remaining electric power in battery 11 from being used for driving the vehicle 10, by having the selection unit 516 switch the source of the electric power supply from the battery 11, the primary battery, to the supplemental battery 511 only. In step 580, the drive mechanism 12 drives the vehicle 10 by using the electrical power of the supplemental battery 511 only, and may restrict the performance of the vehicle 10, such as the speed of the vehicle 10, in order to adjust the electric load placed on the supplemental battery. Therefore, the control unit provided by step 580 is configured to drive the vehicle 10 by using the supplemental battery 511 only, when the battery checker determines that a non-compliant battery 11, the primary battery, is used in the vehicle 10.

### Third Embodiment

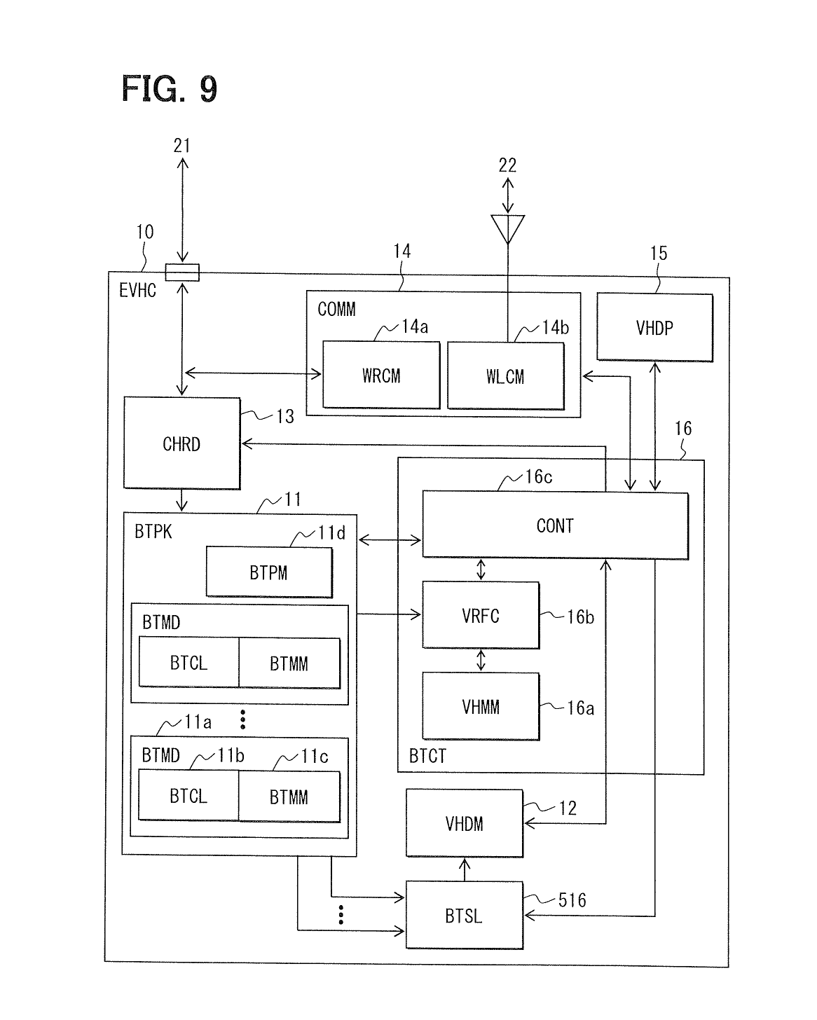

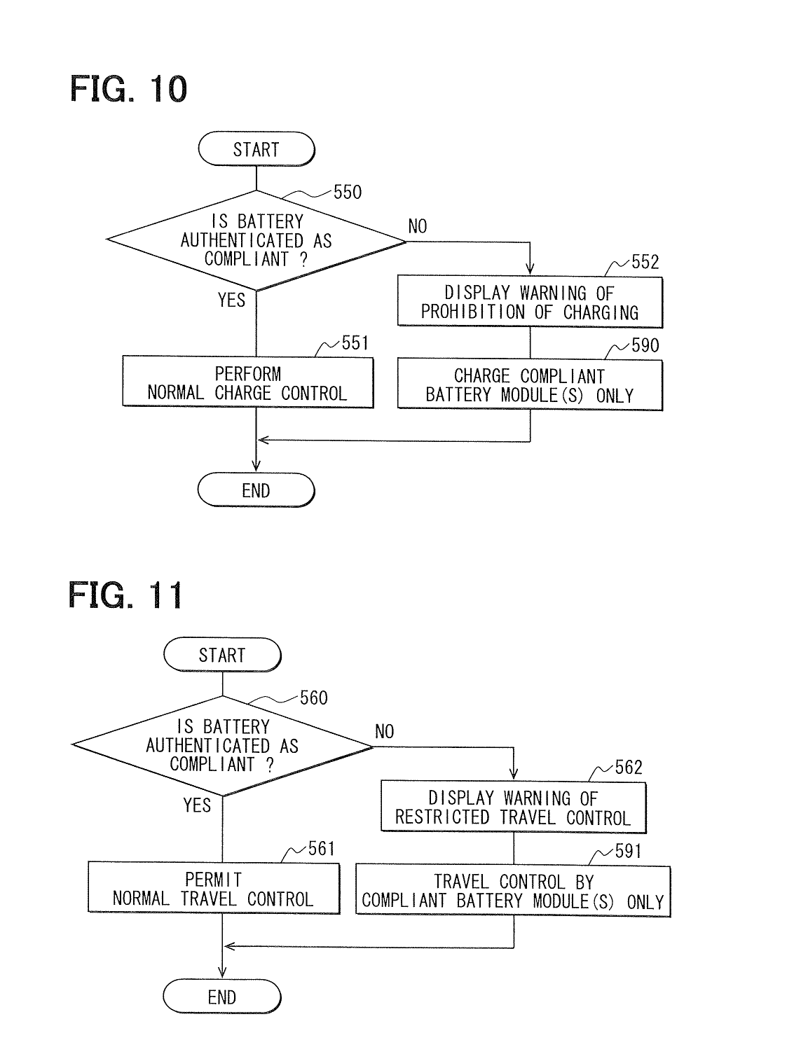

In the third embodiment, the block diagram of a part of the apparatus in the first embodiment shown in FIG. 2 is switched to a block diagram shown in FIG. 9. Further, the charge control process of the first embodiment shown in a flowchart of FIG. 5 is switched to a charge control process shown in FIG. 10. Further, the travel control process of the first embodiment shown in a flowchart of FIG. 6 is switched to a travel control process shown in FIG. 11. System configuration in the third embodiment is also shown in FIGS. 1, 3, and 4.

FIG. 9 is a block diagram of a part of the battery management apparatus disposed in the vehicle 10. Like numbers refer to like steps in FIG. 2. In the present embodiment, the plurality of battery modules 11a may be considered sub-battery-components to the battery 11. Also, the vehicle 10 has the selection unit (BTSL) 516. Based on an instruction from the control unit 16c, the selection unit 516 only selects the compliant sub-battery-component as the power source for the for the drive mechanism 12. In other words only the battery modules 11a that are compliant are selected as the power source for the drive mechanism 12.

Steps 540 to 543 of FIG. 4, serves as the battery checker, and authenticates each of the battery modules 11a. FIG. 10 shows a flowchart of the charge control process of the third embodiment. Like numbers refer to like steps in FIG. 5. In the present embodiment, step 590 is performed when at least one of the battery module 11a is not authenticated, in other words it is non-compliant. In step 590, use of the non-compliant battery module 11a is prohibited, and the charge control process only charges the battery module(s) 11a that are compliant. In step 590, the control unit 16c instructs the selection unit 516 to electrically separate the non-compliant battery module(s) 11a from the compliant battery module(s) 11a completely.

FIG. 11 shows a flowchart of the travel control process of the third embodiment. Like numbers refer to like steps in FIG. 6. In the present embodiment, step 591 is performed when at least one of the battery modules 11a is not authenticated (i.e it is non-compliant). The travel control process drives the vehicle 10 on the electric power supplied from the battery module(s) 11a that are compliant. In step 591, the control unit 16c instructs the selection unit 516 to supply the drive mechanism 12 with the electric power from only the battery module(s) 11(a) that are compliant. In such a case, the control unit 16c has the selection unit 516 switch to only the compliant battery module(s), and does not use the remaining electric power of the non-compliant battery module(s) 11a. In this manner, the electric load of the non-compliant battery modules 11a is restricted. In step 591, the drive mechanism 12 drives the vehicle 10 by using the electric power of the compliant battery modules 11a only. The drive mechanism 12 can restrict, for example, a travel speed of the vehicle 10, in order to adjust the electric load of driving to the electric power supplying capacity of the compliant battery modules 11a. In other words, according to a ratio of the compliant battery modules 11a in the battery 11, the travel speed of the vehicle 10 can be restricted. Therefore, the control unit provided by step 591 is configured to operate the battery-driven device by using the compliant battery modules 11a only, when the battery checker determines that at least one of the battery modules is non-compliant.

### Other Embodiments

Although the present disclosure has been fully described in connection with preferred embodiment thereof with reference to the accompanying drawings, it is to be noted that various changes and modifications will become apparent to those skilled in the art.

Further, for example, the structure of the supplemental battery 511 may be same as the structure of the battery module 11a. Further, a secondary battery may be used as the supplemental battery 511, and may be configured to be chargeable by the charge device 13. Further, the supplemental battery 511 may also be authenticated. In such a case, only the authenticated supplemental battery 511 is used in the travel control.

The above-described embodiments may be combined. For example, when installation/use of the non-compliant battery is detected, the vehicle 10 may be driven by the battery module 11a that is determined as a compliant battery and the internal combustion engine 512b. Further, when installation/use of the non-compliant battery is detected, the vehicle 10 may be driven by the supplemental battery 511 and the internal combustion engine 512b. Furthermore, when installation/use of the non-compliant battery is detected, the vehicle 10 may be driven by the battery module 11a that is determined as a compliant battery, the supplemental battery 511 and the internal combustion engine 512b. Furthermore, when installation/use of the non-compliant battery is detected, the vehicle 10 may be driven by the battery module 11a that is determined as a compliant battery and the supplemental battery 511.

Further, the function of the control unit may be provided solely by software, solely by hardware, or by combination of software and hardware. Further, the control unit may be provided as a digital circuit, or as an analogue circuit.

Such changes, modifications, and summarized schemes are to be understood as being within the scope of the present disclosure as defined by appended claims.

What is claimed is:

1. A battery management apparatus comprising:
a battery checker that determines if a battery used in a battery-driven device is a compliant battery or a non-compliant battery; and
a control unit that operates the battery-driven device by using a power source other than the non-compliant battery, when the battery checker determines that the battery is a non-compliant battery.

2. The battery management apparatus of claim 1, wherein the battery-driven device is a vehicle that uses the battery as a power source.

3. The battery management apparatus of claim 1 further comprising:
a charge prohibition unit that prohibits the non-compliant battery from being charged.

4. The battery management apparatus of claim 1, wherein the control unit operates the battery-driven device by an internal combustion engine without using the non-compliant battery.

5. The battery management apparatus of claim 1, wherein
the battery includes a plurality of sub-battery-components;
the battery checker determines the compliance of selected sub-battery-components of the battery; and
the control unit operates the battery-driven device with sub-battery-components other than the non-compliant sub-battery-components.

6. The battery management apparatus of claim 5 further comprising:
a selection unit that selects the sub-battery-components based on information received from the control unit, to provide the battery-driven device with electric power from sub-battery-components other than the non-compliant sub-battery-components.

7. The battery management apparatus of claim 5, wherein
one of the sub-battery-components is a primary battery;
one of the sub-battery-components is a supplemental battery;
the battery checker determines if the primary battery is compliant or non-compliant; and
the control unit operates the battery-driven device by using only the supplemental battery when the battery checker determines that the primary battery is non-compliant.

8. The battery management apparatus of claim 5, wherein
the sub-battery-components is a plurality of battery modules;
the battery checker determines the compliance of each of the battery modules; and
the control unit operates the battery-driven device by only using the compliant battery modules.
